(19) United States
(12) Patent Application Publication
(10) Pub. No.: US 2008/0232097 A1
(43) Pub. Date: Sep. 25, 2008

(54) FLASHLIGHT HAVING INDEPENDENTLY ADJUSTABLE LEGS

(76) Inventors: Samir Gandhi, Murray Hill, NJ (US); Josh Scharf, Short Hills, NJ (US)

Correspondence Address: DARBY & DARBY P.C., P.O. BOX 770, Church Street Station, New York, NY, 10008-0770, US

(21) Appl. No.: 11/690,690

(22) Filed: Mar. 23, 2007

(51) Int. Cl. F21L 4/00

(52) U.S. Cl. 362/191

(57) ABSTRACT

A flashlight includes a flashlight body and a light source. At least one shape setting leg projects from the flashlight body. The leg is used to arrange the flashlight body in a desirable position so that the beam of light is directed in an intended direction.

### FIELD OF THE INVENTION

The invention generally relates to flashlights and specifically relates to flashlights having shape settable appendages.

### BACKGROUND OF THE INVENTION

Flashlights are useful for a variety of different purposes. Generally, they are designed to be carried. This is disadvantageous when doing manual work. To address this shortcoming of traditional, hand-held flashlights, new designs, such as snake lights, were developed. Snake lights are long flexible flashlights with a light projecting out of one end. A snake light may be bent along its axis into a desired orientation. Accordingly, snake lights can be bent to prop themselves up with the light pointing in a desired direction, or they may be bent around an object to hold their position above the ground. Snake lights typically have power running through their elongate body. Either, batteries are included throughout the body, or a power source is connectable at the end opposite the light, e.g. a USB snake light. As a result, the flexible body of the snake light must be flexible, shape setting, and also must hold wiring and/or batteries. Thus, the reliability of the flashlight as a light is dependent upon the structural integrity of the flexible body. Therefore, the body is relatively expensive to manufacture.

### SUMMARY OF THE INVENTION

The invention provides a flashlight with a flashlight body and at least one shape setting leg extending therefrom. A lighting device is coupled to the flashlight body and receives power from a voltage source housed inside the flashlight body. The legs are flexible or malleable, such that they can be bent into a desired position and remain in that position. Accordingly, the legs can be set in a desired shape and are therefore called shape setting.

The shape setting legs may be used to prop up the flashlight body such that a light beam formed by the lighting device is pointed in a desired direction. Alternatively, the shape setting legs may be wrapped around an object so that the flashlight can hang in a desired position. The shape setting legs can be made of a simple inexpensive construction without risking the integrity of the flashlight itself.

### BRIEF DESCRIPTION OF THE DRAWINGS

These and other objects and features of the invention will become more apparent by referring to the drawings, in which:

FIG. 1 is a perspective view of an embodiment of the invention in a first position;

FIG. 2 is a perspective view of the embodiment of FIG. 1 in a second position;

FIG. 3 is an enlarged exploded view of the flashlight body and a shape setting leg;

FIG. 4 is a perspective view of another embodiment of the invention;

FIG. 5 is a perspective view of still another embodiment of the invention;

FIG. 6 is a top view of yet another embodiment of the invention;

FIG. 7a is a top view of another embodiment of the invention; and

FIG. 7b is a detailed view of a section of FIG. 7a.

### DETAILED DESCRIPTION

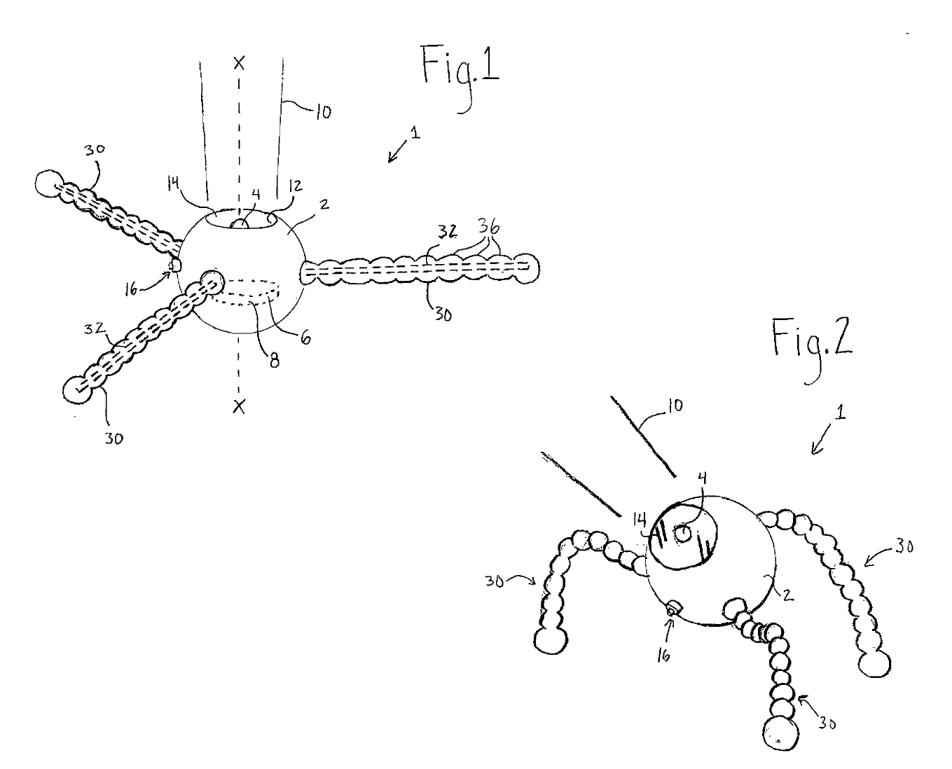

As shown in FIG. 1, the flashlight 1 of the invention includes a flashlight body 2 with a lighting device 4 coupled thereto. In the embodiment shown in FIG. 1, lighting device 4 is directly coupled to flashlight body 2 in that it is housed within body 2. The lighting device 4 can be any type of known device that produces light from electricity, such as a traditional bulb, an LED, an OLED, a compact fluorescent, lamp or other light source. A voltage source 6 is also housed within flashlight body 2 and provides electricity to lighting device 4. In the illustrated embodiment voltage source 6 is shown as a battery 8. However, voltage source 6 may be any portable voltage source such as a super capacitor or a wireless power receiver.

The lighting device 4 produces a beam of light 10 which is directed by a reflector 12. The beam of light 10 optionally passes through a lens 14, as can be positioned on the surface of the flashlight body 2, and travels about of this embodiment an axis X. A switch 16 is included in order to control the power from the voltage source 6 so that the flashlight 1 can be turned on and off. Unlike most flashlights, which are elongate along the axis of the beam of light, the height of the flashlight body 2 along the X axis is no greater than the width or length of the flashlight body 2.

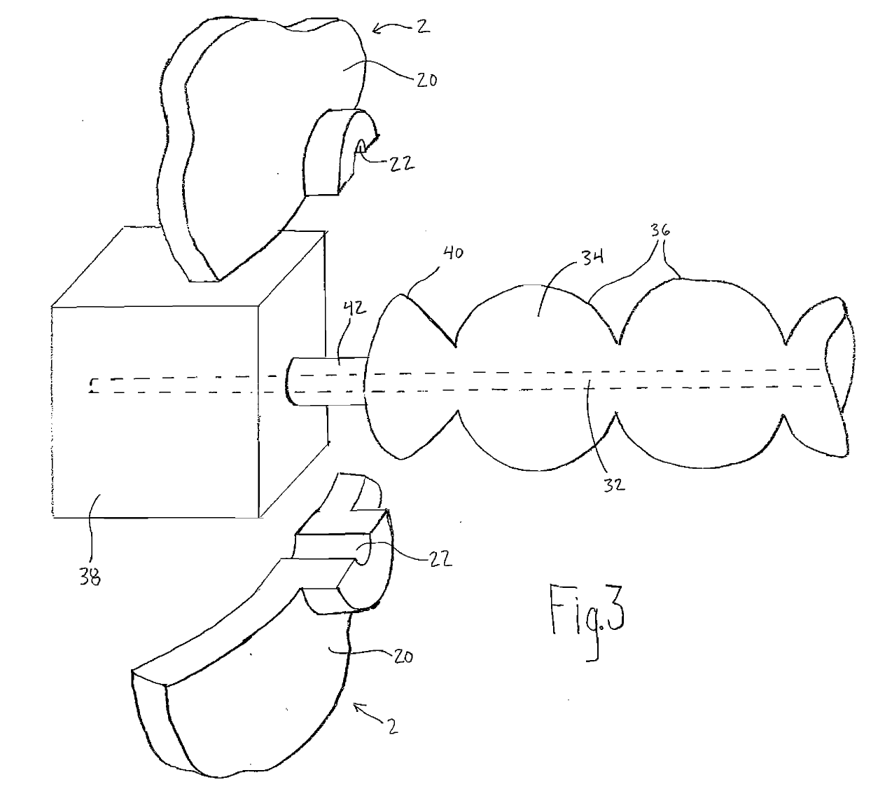

Extending from the flashlight body 2 are three shape settable legs 30. The legs 30 can be bent into a desired shape. Once set in the desired shape, the legs will hold that shape until they are bent into a new one. As a result, the shape setting legs 30 can be bent so that the flashlight can hold itself in any position with the beam of light 10 projecting in a desired direction. As shown in FIG. 2, the legs are bent into a position that holds the flashlight body 2 upright on a surface, and the beam of light 10 is projected at a desired angle. The shape setting legs 30 can also be used to hold the flashlight body 2 around an object, like a pole or a branch. Thus, the flashlight 1 can be suspended in the air with the beam of light 10 projecting in a desired direction.

In the illustrated embodiment of FIG. 1, the shape setting legs include a malleable wire 32 at their core. The wire 32 allows the leg to be repeatedly bent into new shapes and consistently hold that shape. The malleable wire 32 is embedded in an overmold 34. The overmold can comprise a variety of materials such as plastic, rubber or rubberized plastic. In the illustrated embodiments of flashlight 1, the shape setting legs 30 include bumps 36 distributed along their lengths. The bumps 36 help provide added grip when the legs 30 are secured around an object. Accordingly, the flashlight 1 is unlikely to slip, and the flashlight 1 will hold in a position with the beam of light 10 projecting in a desired direction. Optionally, the bumps 36 are evenly distributed

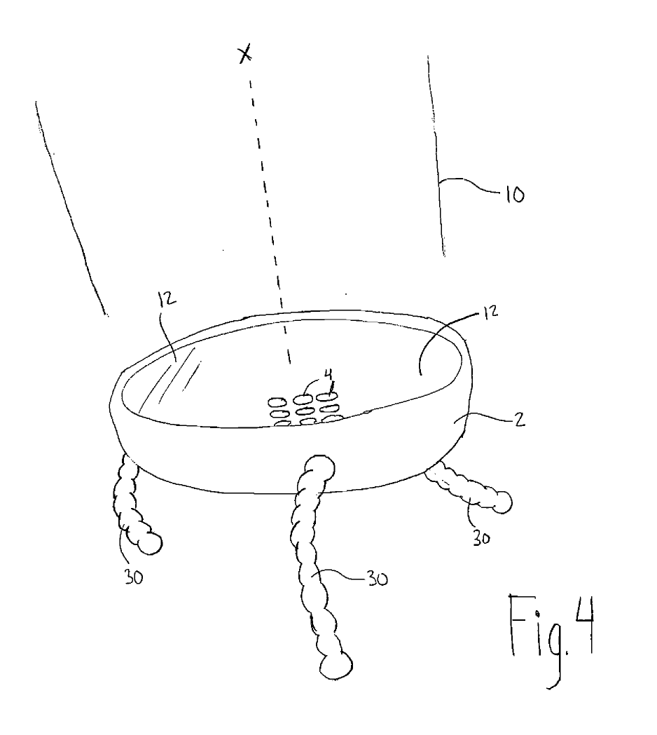

The illustrated embodiment of shape setting leg 30, including a malleable wire 32 embedded in an overmold 34, is an inexpensive construction which can be used to construct a flashlight in accordance with the invention that can project light in a desired direction without requiring that the flashlight 1 be held. Further, the construction of the flashlight body 2 and the coupling of the legs 30 to the flashlight body 2 is also inexpensive. An exemplary method of coupling shape settable legs 30 to flashlight body 2 is shown in FIG. 3. As shown in the figure, the flashlight body 2 is formed of two pieces 20. Each piece 20 can be a plastic material and can be separately injection molded. The flashlight body 2 is formed by attaching the two pieces 20, for example, by using bolts, adhesive or a heat weld. Each of the two pieces 20 optionally includes a groove 22 designed to hold a securing section 42 of the shape settable leg 30. When the two pieces 20 of the flashlight body 2 are attached to one another, the securing section 42 of the shape settable leg 30 is sandwiched between the grooves 22. The shape setting legs 30 are axially restrained by an anchor 38 adjacent the securing section 42 on the inside of the flashlight body 2 and a flange 40 adjacent the securing section 42 on the outside of the flashlight body 2.

The construction thus described has the flashlight circuit, including the light source 4, switch 16 and power source 6 within the housing and independent of the shape settable leg 30 subassemblies. This results in a robust construction as compared to snake lights.

FIG. 4 shows another embodiment of the invention. The flashlight body 2 is in the form of a disk and includes a plurality of lighting devices 4 housed therein. A reflector 12 directs light from the lighting device 4 through a lens 14 along a beam 10. The beam of light 10 travels about the illustrated axis X. The height of the flashlight body 2 along axis X is smaller than both the diameter of the disc, i.e. the width and the length. Three shape setting legs 30 project outward from the flashlight body 2 in a direction that is perpendicular to the X axis. This allows the legs 30 to hold the body 2 in a manner that presents the beam of light 10 in a desirable direction. The light circuit can be as previously described.

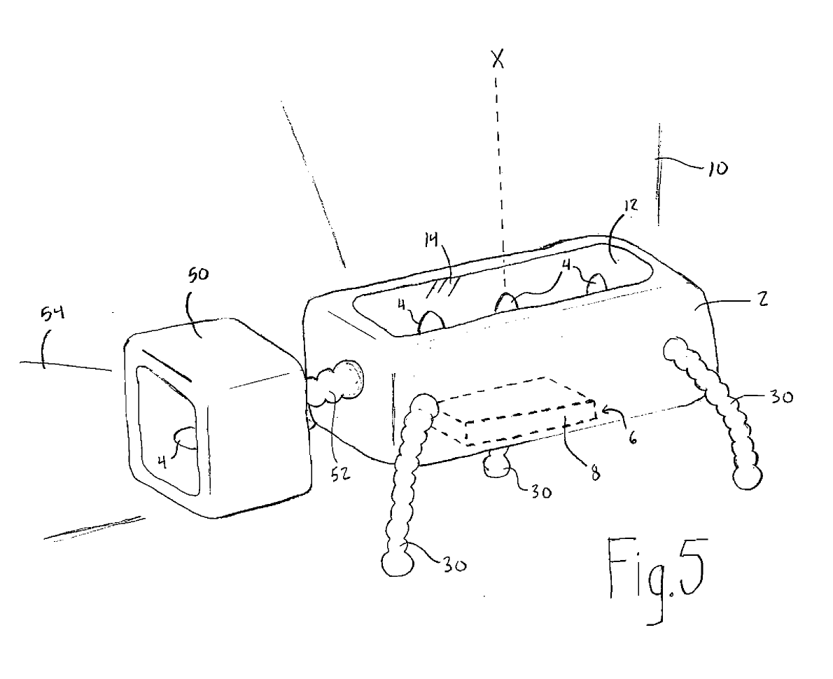

FIG. 5 shows another embodiment of the invention that includes an auxiliary body 50 for additional lighting devices 4. The flashlight 1 includes a flashlight body 2 that houses a number of lighting devices 4. The flashlight body 2 also includes a reflector 12 which directs light from the lighting devices 4 through a lens 12 and about the X axis in the form of a beam 10. A battery 8 or capacitor inside the flashlight body 2 provides power to the lighting devices 4. The height of the flashlight body 2 along the X axis is approximately equal to its width. However, the length of the flashlight body 2 is greater than both the width and the height. Pour shape setting legs 30 extend outward from the flashlight body. At the base of each leg 30 where it is connected to the flashlight body 2, the leg extends from the housing in a direction perpendicular to the X axis.

An auxiliary body 50 is coupled to the flashlight body 2 via a shape setting coupler 52. The auxiliary body 50 also includes lighting devices 4 and provides another beam of light 54 which can project in a second direction which is different than beam of light 10. In the illustrated embodiment, the flashlight 1 only includes one voltage source 6. Power is carried to the lighting device 4 in the auxiliary body 50 through shape setting coupler 52. It is also possible for the auxiliary body 50 to include its own voltage source 6, such that shape setting coupler 52 may be simplified. The shape settable coupler 52 can differ from the shape settable legs 30 in that it may include first and second elongate conductors to convey power from the housing 2 to the housing 50. Optionally, the malleable core provided in the shape settable coupler 52 can serve as one of the elongate conductors.

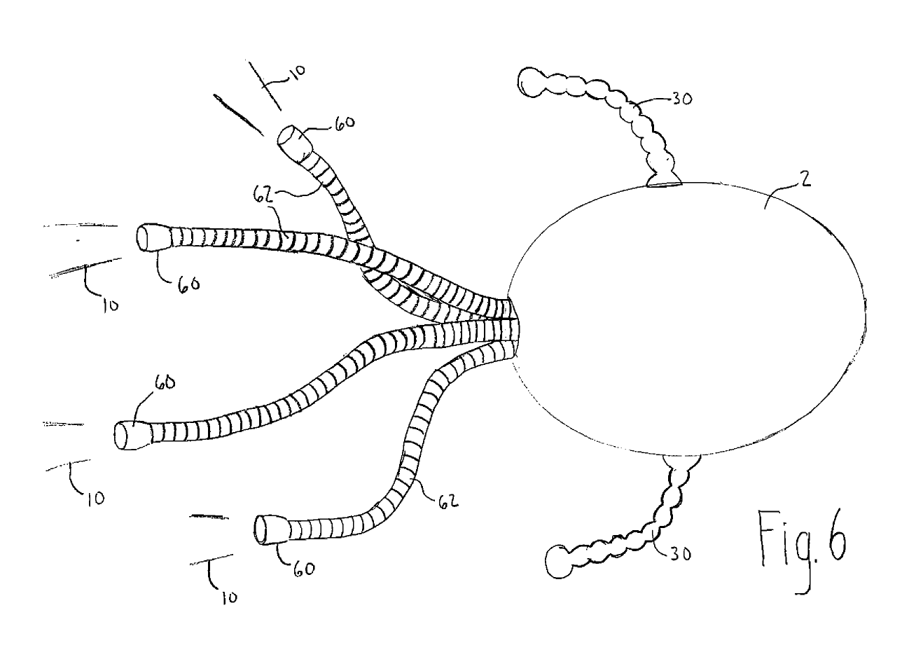

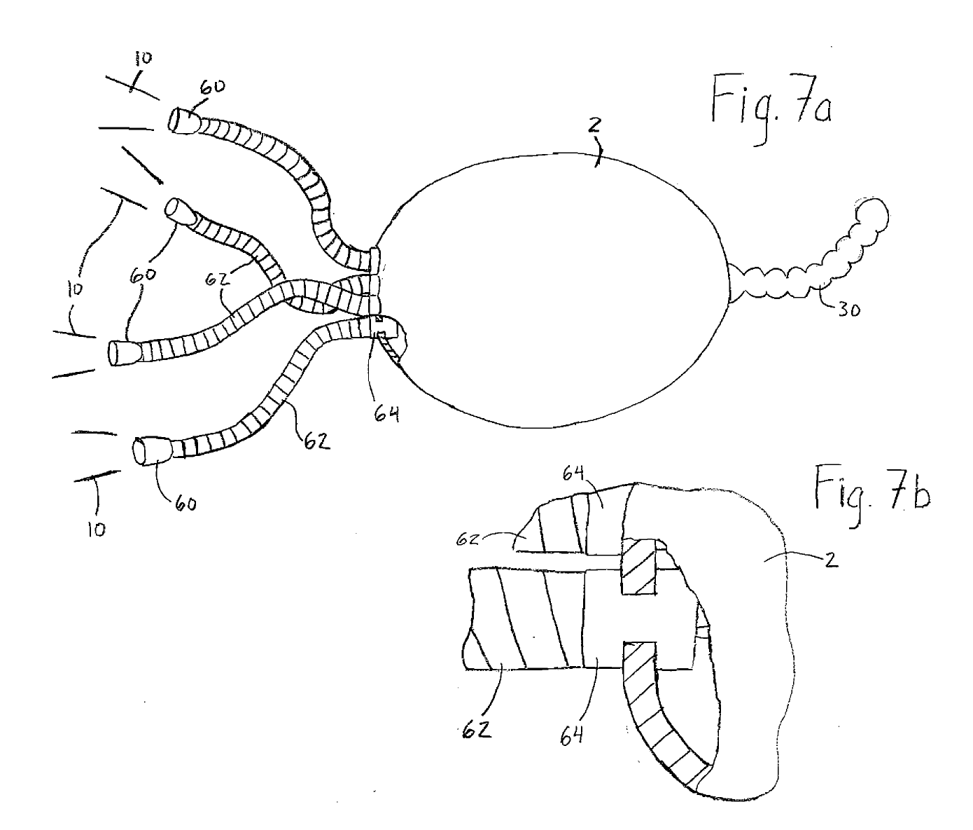

Additional embodiments of flashlight 1 are illustrated in FIGS. 6, 7a and 7b. In each of these illustrated embodiments, a plurality of light sources 4 are each held within a flashlight head 60 that is coupled to flashlight body 2 through a goose neck 62. A goose neck can be constructed using closely spaced coaxial coils. The goose neck includes a base 64 at one end which engages the housing. As shown in the embodiment illustrated in FIG. 7a and shown in detail in FIG. 7b, the base 64 optionally includes a securing section in the form of a groove to secure the goose neck base 64 in the housing 2. A portion of housing 2 can sit within the securing section to axially restrain the goose neck 62, as shown. Each of the goose necks is shape settable such that each beam of light 10 projecting from a respective flashlight head 60 can be arranged in a desired direction. The flashlight body 2, in each of the embodiments of FIGS. 6, 7a and 7b includes a shape settable leg 30 projecting therefrom, as previously described. The embodiment illustrated in FIG. 6 includes two shape settable legs 30 extending from the sides of the flashlight body 2. The embodiment illustrated in FIG. 7a is a variation of that of FIG. 6, having one shape settable leg 30 extending opposite the goose necks 62. The legs 30 are used to hold the flashlight body 2 in a desired location. From the desired location each flashlight head 60 can be arranged to organize a respective individual beam of light. Optionally, the shape settable coupler 52 can be a goose neck.

The features and elements have been described in the foregoing with respect to a particular embodiment of the invention. However, those features can be interchanged and used in other embodiments without departing from the scope of the invention.

Although the preferred form of the invention has been shown and described, many features may be varied, as will readily be apparent to those skilled in this art. It is the intention, therefore, to be limited only as indicated by the scope of the claims appended hereto.

We claim:

1. A flashlight comprising:
a flashlight body;
a light source supported by the flashlight body and selectively coupleable to a voltage source; and
at least one shape settable leg including an anchor at one end and a flange adjacent the anchor,
wherein the at least one shape setting leg is secured to the flashlight body between the flange and the anchor.

2. The flashlight according to claim 1 wherein the at least one shape setting leg includes a malleable wire and a surrounding material.

3. The flashlight according to claim 2 wherein the anchor and the flange comprise a material affixed to the malleable wire.

4. The flashlight according to claim 1 wherein the at least one shape setting leg includes a plurality of bumps along its length.

5. The flashlight according to claim 1 wherein the flashlight body comprises first and second shell sections, and
wherein the shell sections are seated between the anchor and the flange.

6. A flashlight comprising:
a flashlight body having a height along a first axis, a width and a length, the height being not greater than one of the width and the length;
a light source housed within the flashlight body and operable to form a beam of light about the first axis when energized by a voltage source; and
at least two shape settable legs extending from the flashlight body, each leg projecting, at a base thereof, in a direction substantially perpendicular to the first axis.

7. The flashlight according to claim 6 further comprising a reflector within the flashlight body operable to direct the beam of light along the first axis.

8. The flashlight according to claim 6 wherein the height is smaller than the width and the length.

9. The flashlight according to claim 6 wherein the flashlight body is circular about the first axis.

10. The flashlight according to claim 6 wherein the shape setting legs each include a malleable wire and a surrounding material.

11. The flashlight according to claim 10 wherein the shape setting legs include an anchor at one end and a flange separated from the anchor by a securing section, and
wherein the shape setting legs are secured to the flashlight body at the securing section.

12. The flashlight according to claim 11 wherein the anchor and flange comprise a material affixed to the malleable wire.

13. The flashlight according to claim 6 wherein each shape setting leg includes a plurality of bumps along its length.

14. The flashlight according to claim 6 further comprising an auxiliary body coupled to flashlight body by a shape settable coupling member, the auxiliary body including a second light source energizable by the voltage source.

15. A flashlight comprising:
a flashlight body;
at least two goose-neck members attached to the flashlight body;
a light source coupled to each goose neck member at a location remote from the flashlight body and energizable by a voltage source; and
at least one shape setting leg attached to the flashlight body.

16. The flashlight according to claim 15 wherein the at least one shape setting leg includes a malleable wire and a surrounding material.

17. The flashlight according to claim 16 wherein the at least one shape setting leg include an anchor at one end and a flange separated from the anchor by a securing section, and
wherein the at least one shape setting leg is secured to the flashlight body at the securing section.

18. The flashlight according to claim 17 wherein the anchor and flange comprise a material affixed to the malleable wire.

19. The flashlight according to claim 15 wherein the at least one shape setting leg includes a plurality of bumps along its length.

20. The flashlight according to claim 15 wherein the flashlight body comprises first and second shell sections, and
wherein the shell sections are seated around the securing section and between the anchor and the flange.
